(19) United States
(12) Patent Application Publication
(10) Pub. No.: US 2013/0150758 A1
(43) Pub. Date: Jun. 13, 2013

(54) SYSTEM AND METHOD USING A SENSORY FOOT BAND TO IMPROVE BALANCE AND FUNCTION

(71) Applicant: Peter Tilton Cox, JR., Charlotte, NC (US)

(72) Inventor: Peter Tilton Cox, JR., Charlotte, NC (US)

(21) Appl. No.: 13/323,697

(22) Filed: Dec. 12, 2011

(51) Int. Cl. A61H 1/00

(52) U.S. Cl. 601/27

(57) ABSTRACT

A device for improving the balance and function of a human being wearing the device, said device comprising a pressure band adapted to apply force against the weight-bearing pressure of the foot in an outward direction against this device. The sensory response received through the neurological pathways to the brain and the improved neurological signals sent back to the foot could be mechanically and sensory measured for improved balance and bodily improvements.

### FIELD OF THE INVENTION

The present invention relates to a system which is useful for improving a person's balance function and to a method of using the system. More specifically, the present invention relates to a system comprising a sensory foot band particularly positioned about a person's forefoot. The sensory foot band provides a mechanical element that applies pressure to a particular portion of a person's forefoot in response to weight being supported by the forefoot to thereby provide a sensory communication that improves one's sense of balance and function.

### BACKGROUND OF THE INVENTION

Human beings are bipedal and, hence, can stand, walk and run on two legs. Of course, whether standing, walking or running the person must balance on one or both feet. The ability to balance oneself varies from individual to individual. Balance is always important and in some cases is very important.

Generally speaking balance involves one's brain repeatedly accessing and properly utilizing neurological information communicated through spinal pathways to and from the feet. The brain's interpretation of the neurological information produces the sense of balance.

It will be appreciated that there is both a mechanical component and a nerve or sensory component involved in balancing oneself. The bones in each foot and their associated ligaments provide mechanical structure to support the rest of the body on the feet. The sensory component uses joint receptors which communicate through various pathways with the brain. There are various joint receptors and neurological pathways used to communicate sensory information between one's brain and feet in order for one to balance oneself.

It will also be appreciated that some people are able to balance better than others. In some cases, the difference in balance may be due to inherited traits or learned abilities. In other cases, a person's balance may have deteriorated because of injury to the feet. spinal degeneration, defects and or degeneration, poor brain interpretive function, or for other physiological reasons. However, regardless of the quality of a person's balance, it is believed that the person's balance can be improved by use of the present invention.

The present invention relates to a system which uses a pressure band or sensory support element which extends in a particular manner about a predetermined location about the foot. In accordance with the method of the present invention, the system is used to alter the sensory information transmitted to a person's brain from each of the person's feet. The pressure band effectively alters the sensory information sent to the brain and the brain pattern response. Thus, the sensory information communicated between the feet and the brain and the neurological signals being sent from the brain back to the feet in response to the sensory information are altered in a way to improve one's balance and foot function.

Further understanding of the present invention will be had from the following specification taken in conjunction with the attached drawings and appended claims.

### SUMMARY OF THE INVENTION

In accordance with the present invention, a system comprises a sensory foot band which is a pressure and sensory support element for improving the balance and function of a human being wearing the band about the person's foot. The sensory foot band is positioned about the anterior transverse arch of the person's foot. The band is placed about the foot in a manner such that no substantial pressure is applied by the band to the foot when the foot is at rest, i.e., it is not supporting weight. However, the band is placed closely about the foot and is of a substantially inelastic nature so that it effectively opposes flattening of the anterior transverse arch, i.e., transverse outward movement of the anterior ends of the first and fifth metatarsal bones, when the foot supports weight. Thus, weight-bearing pressure of the foot urges the foot outwardly against the pressure band. The band mechanically opposes outward movement of the aforementioned ends of the first and fifth metatarsal bones and further provides a sensory indication which sensory response is received through neurological pathways by the brain. The improved neurological signals sent back to the foot can be mechanically and sensory measured for improved balance, support and body movement.

The system of the present invention can comprise a pressure band alone positioned about the foot. The system can also comprise a pressure band incorporated into a sock or shoe or the like adapted to properly position the band about the foot when in use.

In accordance with the method of the present invention, the system is used to modify sensory and neurological information communicated between a user's foot and brain to improve the user's balance.

### BRIEF DESCRIPTION OF THE DRAWINGS

FIG. 1 is a perspective view showing a preferred embodiment of the present invention in operative association with a person's foot;

FIG. 2 is a top plan view showing the bones of a person's foot and the preferred positioning of the embodiment of Figure with respect thereto;

FIG. 3 is a perspective view of the preferred embodiment of FIG. 1;

FIG. 4 is perspective view of an alternative preferred embodiment of a sensory band of the present invention having a predetermined limited elastic feature;

FIG. 5 is a longitudinal cross-sectional view of an alternative preferred embodiment of the present invention in the form of a sock comprising a sensory foot band;

FIG. 6 is a longitudinal cross-sectional view of another alternative preferred embodiment of the present invention in the form of a sock having a sensory foot band attached thereto;

FIG. 7 is a side elevation view showing another alternative preferred embodiment of the present invention in the form of a shoe having a sensory foot band incorporated therein;

FIG. 8 is a cross-sectional view taken along line 8-8 in FIG. 7 showing the sensory foot band incorporated in the shoe of FIG. 7;

FIG. 9 is a perspective view of still another preferred embodiment of the present invention shown in conjunction with a human foot, broken away, and in the form of a flip flop type of sandal having a sensory foot band incorporated therewith;

FIG. 10 is a top plan view of the embodiment of FIG. 9; and

FIG. 11 is a top plan view of yet another preferred embodiment of the present invention in the form of a five toe shoe incorporating a sensory foot band.

### DESCRIPTION OF THE INVENTION

In accordance with the present invention, a system comprising a sensory foot band has been developed. The sensory foot band can be placed in operative association with a human foot and used to improve the balance of the human being. In use, the band functions to apply pressure against the foot when weight is placed on the foot. The pressure generates sensory neurological fiber stimulation within the foot. Neurological information is sent from the foot to the brain using pathways to the brain. The brain then sends improved neurological sensory signals back to the foot to improve the person's balance and function of the feet, even the entire body. Based on this theory of operation, it can he noted that a person's posture, overall individual knee, hip, shoulder, and even neck function can be improved based on the sensory responses from the body from the improved signals from the brain due to use of the sensory foot band of this invention.

Sensory and mechanical tests could be used to measure a person's balance and/or performance before the person has utilized the system and after the person has utilizing the system. There are improved efficiencies of the person's functional outputs. The person's level of exertion can be improved along with an increase in endurance, strength, and range of motion throughout the body due to the improved neurological pathways of communication due to the use of the system. There are improved efficiencies of the wearer's level of exertion in order to perform activities. There is improved balance along with increased endurance, strength, and range of motion due to the improved neurological communication during use of, and in accordance with the method of, the present invention.

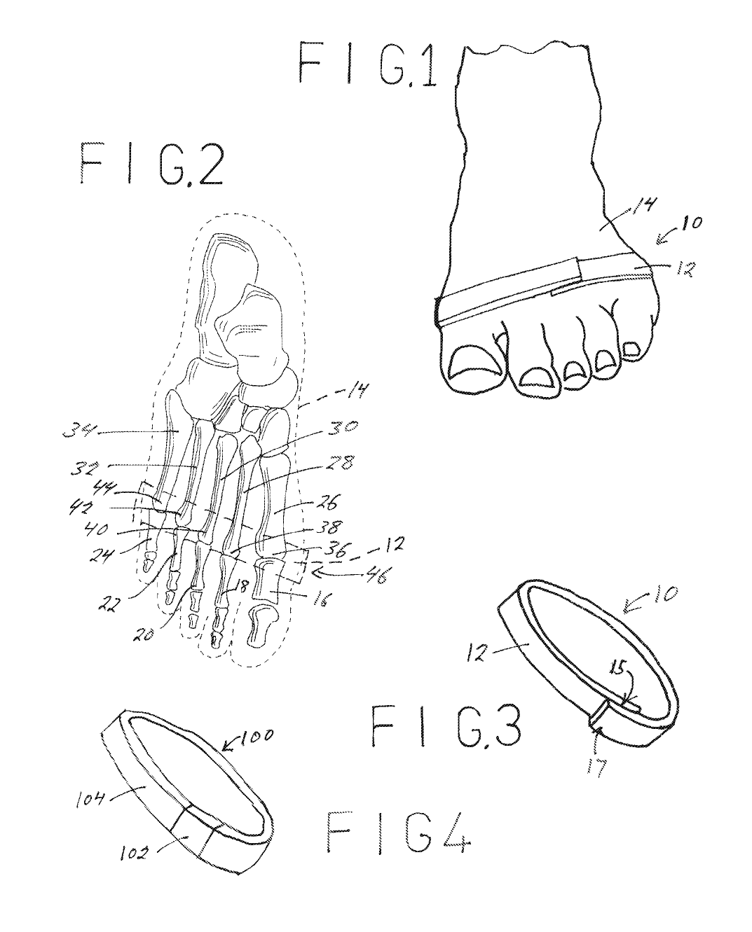

Now referring to the Figures, a preferred embodiment of a system of the present invention is shown in FIG. 1 and indicated generally by the numeral 10. System 10 comprises sensory foot band 12 properly positioned on human foot 14.

As best shown in FIG. 2, the bones of human foot 12 comprise phalanxes 16, 18, 20, 22 and 24 which are respectively proximate to and articulate with, corresponding metatarsal bones 26, 28, 30, 32 and 34, each of which have respective anterior ends 36, 38, 40, 42 and 44. Metatarsal anterior ends 36, 38, 40, 42 and 44 form anterior transverse arch 46. Anterior arch 46 has the form of an “arch” in a generally vertical plane as viewed from the forward end of foot 14. Foot band 12 is shown in FIG. 2 properly positioned around anterior arch 46. Foot band 12 is positioned closely about foot 12 but is sized so as not to apply any substantial pressure against foot 12 until foot 12 bears weight as set forth in more detail below.

Sensory foot band 12 can be made of any suitable material which is substantially inelastic. Suitable materials include textiles, polymeric sheets, and athletic tape. Sensory foot band 12 is secured on foot 14 in a manner that no pressure is applied thereby to foot 14 when foot 14 is at rest, i.e., is not bearing weight. However, it is intended that sensory foot band 12 will oppose lateral movement of metatarsal anterior ends 36 and 44 when weight is applied to foot 14. When foot 14 supports a person's weight, anterior arch 46 tends to flatten and sensory foot band 12 acts to oppose such motion. Thus, foot band 12 can be a continuous loop or can be a length or strip of material with ends 15 and 17 secured together by adhesive, hook and loop fasteners or other suitable means.

During the use operation of sensory foot hand 12 the person wearing the band 12 has improved balance. As the wearer puts weight or “bears down” on foot 14, the weight causes outward expansion of the wearer's foot against the device. This in turn results in the sensory stimulation up the neurological pathways, from each foot, to the brain. As previously explained, sensory and motor neurological response signals from the brain are in turn sent back to each foot. The sensory input to pressure of this band against the wearer's feet causes the neurological responses and affects an improvement in the wearer's balance and foot functions. Also noted before, there is overall additional improvements to form and function of the entire body due to improved proper biomechanical function of the feet.

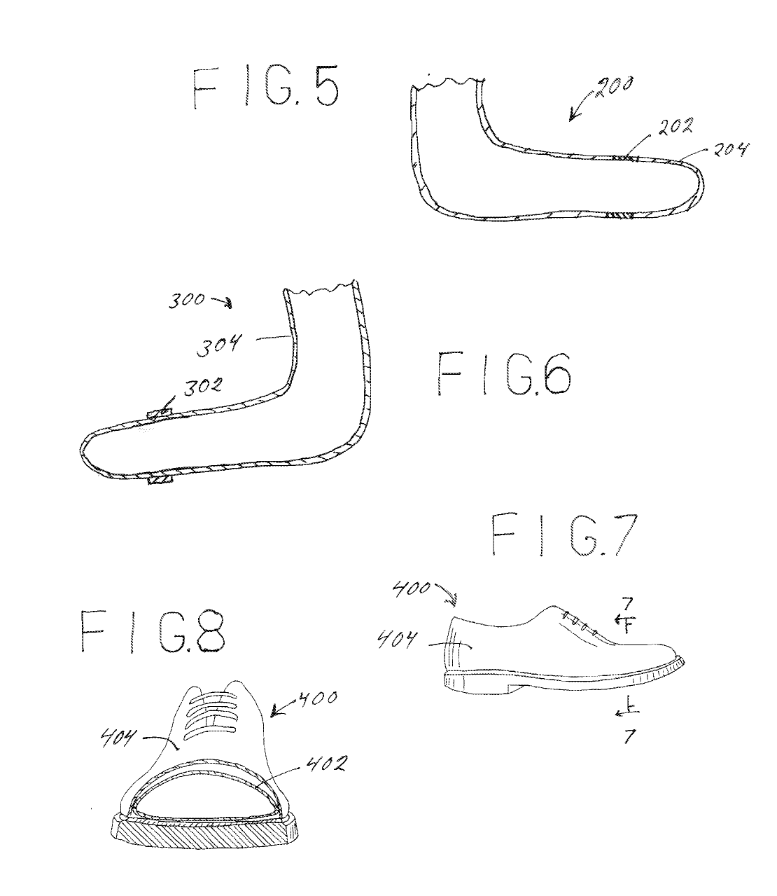

FIG. 4 illustrates an alternative preferred embodiment of a sensory foot band of this invention, indicated generally by the numeral 100. Sensory foot band 100 incorporates an elastic section 102 which is comprised of a material characterized by being elastic to a predetermined length only in order to facilitate use of a continuous loop sensory foot band in accordance with the present invention. It is intended that band 100 comprises a section 102 which is elastic to a predetermined length and then inelastic and an section 104 which inelastic. Alternatively, both sections may be the same or different and may be characterized by limited elasticity so long as the band is inelastic at a predetermined length or diameter so as to function in accordance with the present invention wherein no significant pressure is applied to the foot thereby until the foot bears weight. Provision of limited elasticity may facilitate positioning of the band about the users foot. Band 100 thus operates in a manner analogous to the operation of band 10.

Referring to FIGS. 5 and 6, two alternative preferred forms of a system of the present invention are illustrated in the form of socks and indicated generally by the respective numerals 200 and 300. System or sock 200 comprises a sensory foot band 202 incorporated into its sock-shaped generally tubular sheath 204. The wearer of sock shaped tubular sheath 204 positions band 202 around the associated foot's anterior transverse arch in a manner analagous to the use of system 10. Thus, band 202 is positioned around the foot proximate to the proximal joint of the great toe and proximal joint of the fifth toe. Sock 200 can encompass the entire foot, dorsal and pedal, crossing the distal tarsal bones proximal to the second third and fourth proximal joints. Sock 200 would appear similar to any common sock but carries embedded within it a sensory foot band. Band 202 can be provided by weaving inelastic threads, or selectively inelastic threads analogous to section 102 of band 100, into sock 200 at the location of band 202. Sock 200 may optionally have other features such as an increased fiber count at band 202 to provide the desired elastic limit. Sock 200 can be worn in conjunction with a sneaker, sandel or other type of shoe or worn without a shoe covering. It is band 202 which produces the therapeutic benefit for the person. Sock 200 can also be constructed of a tougher material which could be worn as a shoe or protective foot covering by itself. It would have band 202 built into it so the wearer would receive the benefits of the present invention without use of another accessory.

Referring to FIG. 6, another sock preferred embodiment of this invention is shown and indicated generally by the numeral 300. Sock 300 has a sensory foot band 302 secured outside of a sock-shaped generally tubular sheath 304. Alternatively, band 302 can be secured to the inside surface of sheath 304. It is contemplated that band 302 will be generally analogous to band 10, band 100 or band 202.

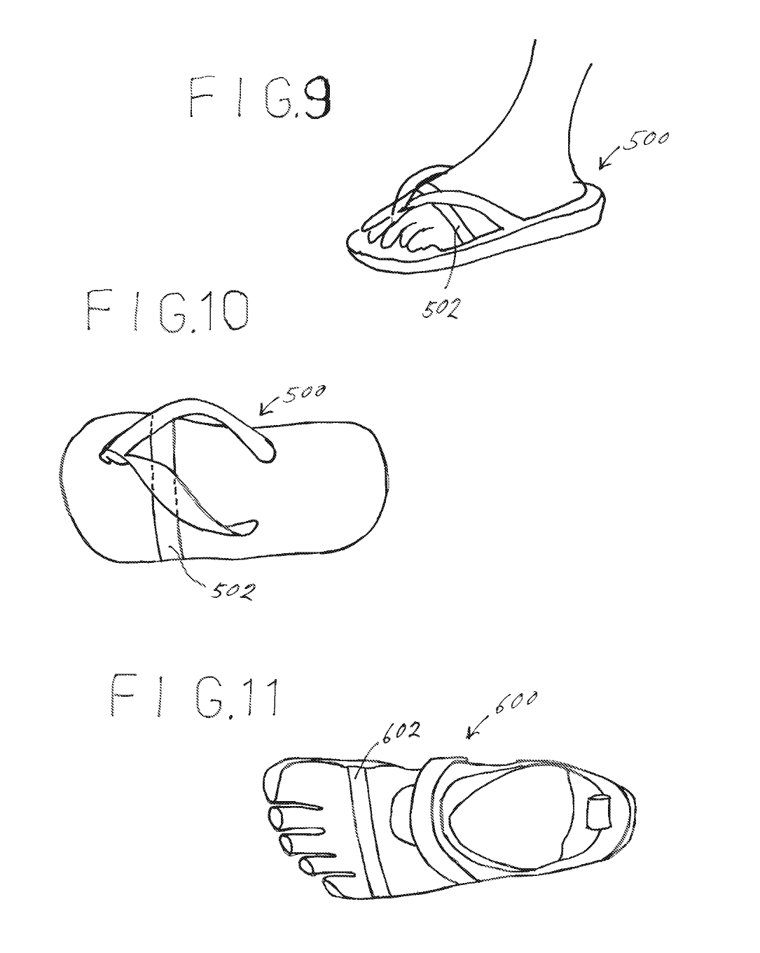

Now referring to FIGS. 7 and 8, an alternative preferred embodiment of a device of the present invention is shown in the form of a shoe generally by the numeral 400.

System 400 has a sensory foot band 402 incorporated into shoe 404. Sensory foot band 402 can be incorporated through the outside of the top, (dorsal), medial and lateral aspects of the shoe and then inserted underneath the foot and between the insole of the base of the shoe. Means could be provided so that the position of sensory foot band 402 could be adjusted to proper position with respect to the foot and/or tightened or loosened, to the predetermined tension necessary to elicit the proper neurological response in accordance with the present invention.

If the shoe is more of a soft sole shoe, similar to the shoes that have individual toes and is constructed of more of a silicon or like material, then the device would be one band constructed around the outside of the entire shoe, yet part of the shoe itself. As previously mentioned, when describing the band's anatomical position within the sock, it would be located on the wearer's foot in a similar anatomical position based on the size of the shoe. It will be appreciated by those skilled in the art that band 402 is intended to be analogous to bands 10, 100, 202 and 302 previously disclosed.

Still further preferred embodiments of the present invention are illustrated in FIGS. 9-11 which illustrate systems incorporating a sensory foot band of this invention into a flip flop type sandal, indicated generally by numeral 500, and into a five toe shoe, indicated generally by the numeral 600. It will be appreciated that sandal 500 has a sensory foot band 502 which is analogous to the foot band previously disclosed and five toe shoe 600 has foot band 602 which is also analogous to the previously disclosed sensory foot bands.

It will be appreciated that this present invention has been described in terms of preferred embodiments and that the invention is subject to variation and modification. For example, the sensory foot band of the present invention could be made of a soft piece of material able to be slightly altered for tension and position to create the ideal neurological response. The actual tension of the band required for the brain to respond to its presence is so light that it is hardly noticeable whether the device is directly on the wearer's foot, built into a sock, or integrated into the structure of a shoe. It could be made of a thin Teflon type of material, similarly applied as a specific type of tape. It could be made of a woven fabric adjustable by the use of Velcro at the top, dorsal, aspect of the foot. It would be constructed of various materials that would be strong enough to endure various levels of activity. Light activity such as supporting proper activities of daily living walking around a person's home indoors and outdoors, driving a car to do errands and the type of ground surfaces encountered, or even for jogging 5 miles worn inside of a shoe, under a sock, or for the extreme barefoot runners, without any outside protection other than this band. It would therefore function as a protective device to the wearer's foot from debris encountered along roadsides, sidewalks and even running on the beach or wooded paths. It will be further appreciated that the broad scope of this invention is intended to include variations and modifications and it is intended that the present invention will be limited only by the appended claims.

What is claimed is:

1. A sensory foot band adapted to be positioned about the anterior transverse arch of a person's forefoot for improving the balance of the person, said band comprising an inelastic pressure band sized to apply force against the person's transverse arch selectively only when said arch is urged transversely in response to said forefoot bearing weight.

2. The foot band of claim 1, wherein said band is a continuous loop.

3. The foot band of claim 1 wherein said band is a strip with ends which are removably secured together.

4. The foot band of claim 1 wherein said band comprises a section having a predetermined limited elastic length.

5. The foot band of claim 1 wherein said band is in combination with a sock.

6. The foot band of claim 5 wherein said band is woven into said sock.

7. The foot band of claim 5 wherein said sock has a tubular sheath to which said band is attached.

8. The foot band of claim 1 wherein said band is in combination with a shoe.

9. The foot band of claim 8 wherein said shoe has an interior forefoot portion and said band is located therein.

10. The foot band of claim I wherein said band is in combination with a sandal.

11. The foot band of claim 1 wherein said band is in combination with a five toed shoe.

12. A method of improving a person's balance, said person having a foot with an anterior transverse arch, said method comprising the steps of:
(A) providing a sensory foot band of predetermined diameter; and
(B) securing said band around said anterior transverse arch in a manner to apply force against the transverse arch selectively only when said arch is urged transversely in response to said foot bearing weight.

13. The method of claim 12 wherein said band is a continuous loop.

14. The method of claim 12 wherein said band is a strip with ends removably secured together.

15. The method of claim 12 wherein said band comprises a section having a predetermined limited elastic length.

16. The method of claim 12 wherein said band is in combination with a sock.

17. The method of claim 12 wherein said band is woven into said sock.

18. The method of claim 12 wherein said band is in combination with a shoe.

19. The method of claim 12 wherein said band is in combination with a sandel.

20. The method of claim 2 wherein said band is in combination with a five toed shoe.
